(19) United States
(12) Patent Application Publication
(10) Pub. No.: US 2003/0194052 A1
(43) Pub. Date: Oct. 16, 2003

(54) Methods for identification and verification

(76) Inventors: L. Stephen Price, Richland, WA (US); Robert Shannon, Burbank, WA (US); Therese Howe, Kennewick, WA (US); Bruce Kaiser, Draper, UT (US)

Correspondence Address: KENNETH E. HORTON, KIRTON & MCCONKLE, 60 EAST SOUTH TEMPLE, SUITE 1800, SALTLAKE CITY, UT, 84111, US

(21) Appl. No.: 10/122,079

(22) Filed: Apr. 12, 2002

(51) Int. Cl. G01T 1/36; G01N 23/223

(52) U.S. Cl. 378/45

(57) ABSTRACT

Apparatus and methods in which one or more elemental taggants that are intrinsically located—or extrinsically placed—in an object are detected by x-ray fluorescence analysis to identify or track/trace the object or its point of manufacture, as well as to establish the origin of objects and their authenticity. The taggant is manufactured as part of the object or the taggant is placed into a coating, packaging, label, or otherwise embedded within or onto the object for the purpose of later verifying the presence or absence of these elements by x-ray fluorescence to determine the unique elemental composition of the taggant within the respective object. The apparatus and methods can used in combination with, in place or, or in additional to current anti-counterfeiting technologies. By using x-ray fluorescence analysis, the apparatus and methods are simple and easy to use, as well as provide detection by a non line-of-sight method to track and trace objects, as well as to establish the origin of objects, their point of manufacture, and their authenticity.

### FIELD OF THE INVENTION

The invention generally relates to apparatus and methods for identification and verification. More particularly, the invention relates to apparatus and methods for detecting an element or elements intrinsically present—or extrinsically added—in an object by using X-ray fluorescence to identify and verify that object. Even more particularly, the invention related to apparatus and methods for detecting an element or compound intrinsically present—or extrinsically added—in an object by using X-ray fluorescence to identify and verify the elemental taggant(s), thereby tracking and tracing those objects.

### BACKGROUND OF THE INVENTION

There has been significant interest in apparatus and methods for identifying and verifying various articles or products (or objects) such as explosives, ammunition, paint, petroleum products, and documents. Known methods used to identify and verify such objects generally involve adding and detecting materials like microparticles, bulk chemical substances, and radioactive substances. Similar marking methods include inks that are transparent in visible light are sometimes applied to objects and the presence (or absence) of the ink is revealed by ultraviolet or infrared fluorescence. Other methods include implanting microscopic additives that can be detected optically. Other methods used for identifying and verifying objects include those described in U.S. Pat. Nos. 6,106,021, 6,082,775, 6,030,657, 6,024,200, 6,007,744, 6,005,915, 5,849,590, 5,760,394, 5,677,187, 5,474,937, 5,301,044, 5,208,630, 5,057,268, 4,862,143, 4,485,308, 4,445,225, 4,390,452, 4,363,965, 4,136,778, and 4,045,676, as well as European Patent Application Nos. 0911626 and 0911627, the disclosures of which are incorporated herein by reference.

As well, there has been significant interest in using similar methods to collect and record data about an object. In particular there has been significant interest to track and trace objects using these methods, e.g. to prevent loss or counterfeiting. Recognizing that manual data collection and keyed data entry were inefficient and error-prone, many industries adopted bar code technology in the mid 1980s. Bar codes were determined, however, to not be suitable for direct part (or object) marking (DPM). Instead, bar codes were used on labels or other packaging for the object or part.

To obtain direct part marking, many industries—together with U.S. governmental agencies—developed machine-readable two-dimensional (2-D) symbols designed to be applied to non-paper substrates. This development resulted in the Data Matrix symbol technologies that could be applied to the materials of most products or objects without impacting performance. Additional part marking technologies quickly followed and were adopted by the automotive, electronics, pharmaceutical, and aircraft industries. These industries relied heavily on the use of mold, cast, or forge; engraving; electrical arc pencil; electrical-chemical marking; embossing; hot stamp; rubber ink stamp; stencil and silk screen; vibration-etch; and add-on tags for part identification.

These marking methods, originally designed to apply human-readable markings, did not successfully apply micro-size (1/32-inch to 15/64-inch square), high-density machine-readable symbols. Their manual operations also added to the large number of data transposition errors associated with paper-based manufacturing systems. Thus, industries began to refine existing marking methods so they could be utilized to apply 2-D symbols. The manual metal stamp, vibro-etch, and embossing technique methods were replaced by dot peen machines. Automated micro-profilers were designed to replace the manual cutting wheel used to produce paint stencils. Photo stencils and thermal printing materials were developed to replace the direct impact electro-chemical marking stencil materials. Ink jet and adhesive dispensing machines were built to replace rubber stamps. Laser marking systems were designed to replace the electric-arc etch and hot stamp processes. See, for example, “Applying Data Matrix Identification Symbols on Aerospace Parts” NASA Technical Standard NASA-STD-6002 (Jul. 2, 2001) and “Application of Data Matrix Identification Symbols to Aerospace Parts Using Direct Part Marking Methods/Techniques” NASA Technical Handbook NASA-HDBK-6003 (Jul. 2, 2001), the disclosures of which are incorporated herein by reference.

Unfortunately, many of the apparatus and methods for identifying and tracking/tracing objects are unsatisfactory for several reasons. First, they are often difficult and time-consuming. In many instances, a sample of the object (of the object itself) must be sent to an off-site laboratory for analysis. In other instances, the apparatus are often expensive, large, and difficult to operate. In yet other instances, the ability of the methods are limited to two-dimensional structures or are limited because of the type of substrate/material used in the object or product.

The known apparatus and methods for identification and tracking/tracing are also unsatisfactory because they require a “line-of-sight” analysis method. This line of sight requirement entails that the apparatus must be able to “see” the taggant in order to detect it. This can be detracting when it would be desirable to detect the taggant without having to see the taggant, e.g., such as when the taggant is located in the middle of large package with packaging and labels “covering” the taggant or when the taggant is not on the surface of the object in which it is located.

### SUMMARY OF THE INVENTION

The invention provides an apparatus and method in which one or more elemental taggants that are intrinsically located-or extrinsically placed-in an object are detected by x-ray fluorescence analysis to identify or track/trace the object or its point of manufacture. The taggant is manufactured as part of the object or the taggant is placed into a coating, packaging, label, or otherwise embedded within or onto the object for the purpose of later verifying the presence or absence of these elements by x-ray fluorescence to determine the unique elemental composition of the taggant within the respective object. The apparatus and methods can be used in combination with, in place of, or in additional to current anti-counterfeiting technologies.

By using x-ray fluorescence analysis, the apparatus and methods of the invention are simple and easy to use, as well as provide detection by a non line-of-sight method. The apparatus and methods can be used to track and trace objects, as well as to establish the origin of objects, their point of manufacture, and their authenticity. The invention is extremely advantageous because it is difficult to replicate, simulate, alter, transpose, or tamper with. Further, it can be easily recognized by a user in either overt or covert form, easily verified by a manufacturer or issuer, and easily applied to various forms of media in the objects, without the limitations experience by current anti-counterfeiting technologies.

### BRIEF DESCRIPTION OF THE DRAWINGS

FIGS. 1, 2a, 2b, 3, 4a, 4b, and 5-8 are views of one aspect of apparatus and methods according to the invention, in which:

FIG. 1 generally depicts the operation of XRF;

FIG. 2a and 2b illustrate the operation of XRF at the molecular level;

FIG. 3 shows an exemplary x-ray spectrum, e.g., for paper;

FIG. 4a and 4b depict two aspects of the of the XRF apparatus of the invention;

FIG. 5 illustrates exemplary energy levels of x-rays in an x-ray spectrum;

FIG. 6 shows another aspect of the XRF apparatus of the invention; and

FIGS. 7 and 8 illustrate aspects of identification technologies that can be used in combination with the invention;.

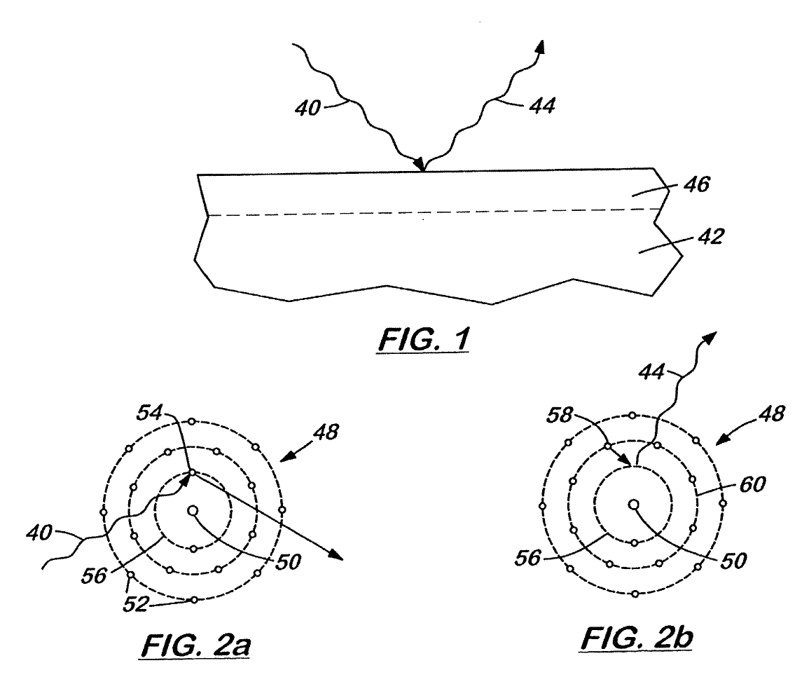

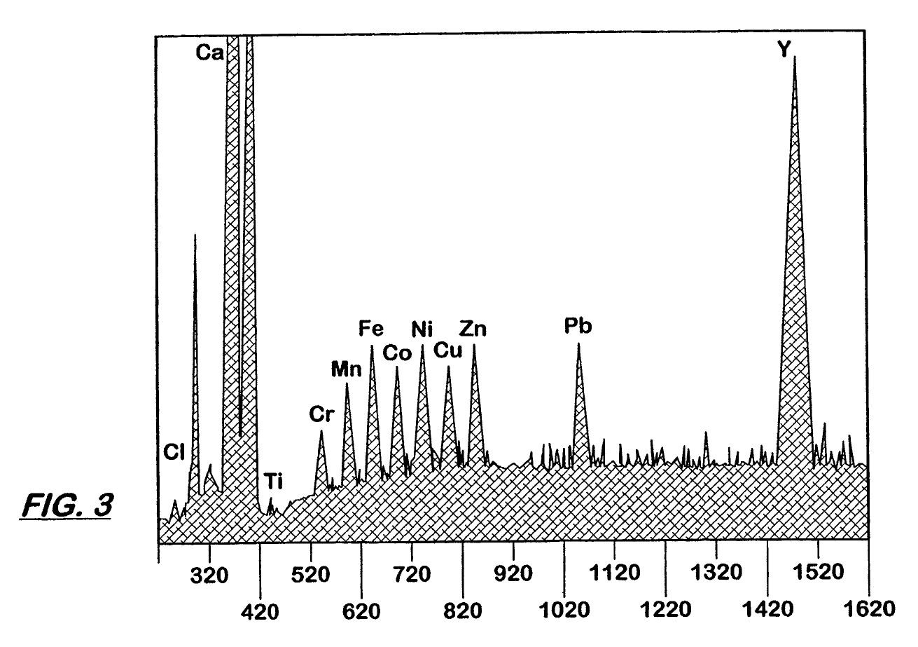

FIGS. 1, 2a, 2b, 3, 4a, 4b, and 5-8 presented in conjunction with this description are views of only particular-rather than complete-portions of apparatus and methods according to the invention. Together with the following description, the Figures demonstrate and explain the principles of the invention.

### DETAILED DESCRIPTION OF THE INVENTION

The following description provides specific details in order to provide a thorough understanding of the invention. The skilled artisan will understand, however, that the invention can be practiced without employing these specific details. Indeed, the invention can be practiced by modifying the illustrated apparatus and method and can be used in conjunction with apparatus and techniques conventionally used in the industry. For example, the invention is described with respect to apparatus and methods for identifying and tracking/tracing objects using taggants in combination with two-dimensional data labels. The invention described below, however, could be easily modified to be used in combination with other anti-counterfeiting technologies. Indeed, the invention could be modified to be used in place of (or in addition to) other anti-counterfeiting technologies.

The invention uses x-ray fluorescence analysis to detect at least one elemental taggant intrinsically or extrinsically present in the material of an object. With x-ray fluorescence (XRF) analysis, x-rays produced from electron shifts in the inner shell(s) of atoms of the taggants and, therefore, are not affected by the form (chemical bonding) of the article being analyzed. The x-rays emitted from each element bear a specific and unique spectral signature, allowing one to determine whether that specific taggant is present in the product or article.

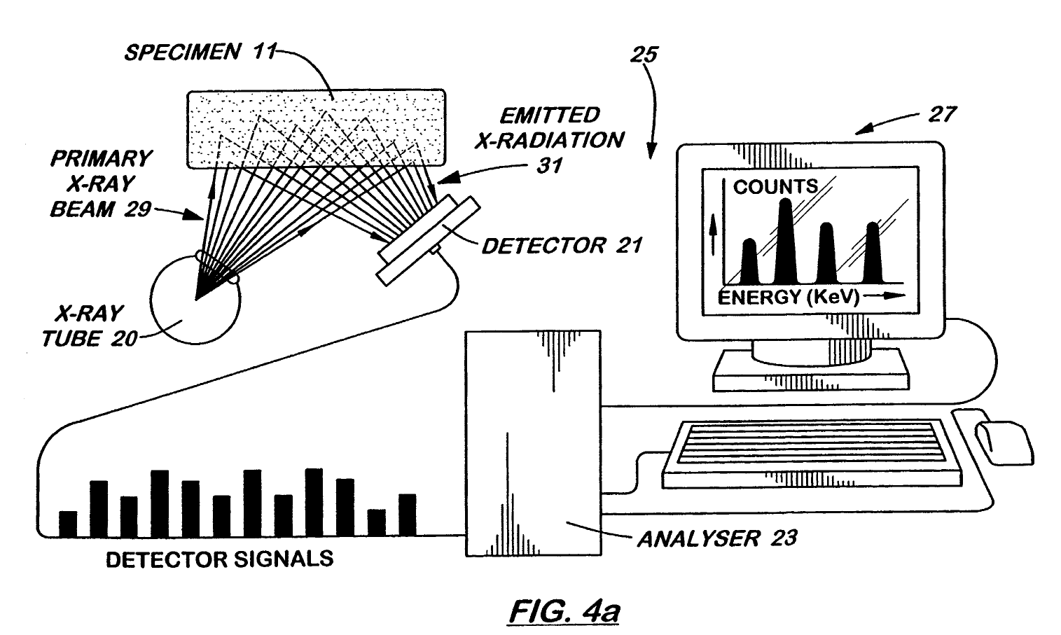

FIGS. 1, 2a, and 2b represent how it is believed XRF generally operates. In FIG. 1, primary gamma rays or x-rays 40 are irradiated on a sample of a target material 46 of article 42. Secondary x-rays 44 are emitted from that sample of target material 46.

In FIGS. 2a and 2b, atom 48 of a taggant located within target material 46 has nucleus 50 surrounded by electrons 52 at discrete energy bands around the nucleus 50 (called electron shells). Each electron has a binding energy level equal to the amount of energy required to remove that electron from its corresponding shell. The innermost shell is the K shell, and has the highest binding energy levels associated with it. Electron 54 is located within K shell 56.

Primary x-ray or gamma ray photon 40 impacting atom 48 has a given energy. If that energy is greater than the binding energy level of K shell 56, the energy of x-ray photon 40 is absorbed by atom 48, and one of the electrons in K shell 56 (i.e., electron 54) is ejected. With a vacancy now in K shell 56 left by electron 54, atom 48 is energetic and unstable. To become more stable, that vacancy in K shell 56 can be—and usually is—filled by an electron located in a shell with a lower binding energy level, such as L-shell electron 58 in L shell 60. As L-shell electron 58 fills the vacancy in K shell 56, atom 48 emits a secondary x-ray photon 44. The energy levels (or corresponding wavelengths) of such secondary x-ray photons are uniquely characteristic to each elemental taggant, allowing the presence or absence of any specific taggant to be determined.

The taggant can be intrinsically or extrinsically present in the object to be detected (the “target object”). When the taggant(s) is intrinsically present, it is a component (either as an element, compound, or other type of composition) in at least one portion of that target object. When the taggant(s) is extrinsically present, it can be added, incorporated, or inserted into the target object as described below.

The at least one taggant employed in the invention can be any suitable taggant known in the art. See, for example, U.S. Pat. Nos. 5,474,937, 5,760,394, and 6,025,200, the disclosures of which are incorporated herein by reference. Suitable taggants include any element capable of being detected via XRF. The type of elements that can be used as the taggant are theoretically any of those listed in the periodic table, but the lower energy emitted by electrons in the lower atomic-number elements could be a limiting factor. Such lower energies can be re-absorbed much easier into its own material matrix or, in some cases, into the ambient atmosphere (e.g., air). Further, different isotopes of an element, as well as elements that “excite” only under certain conditions could be employed as the taggant in the invention. Example of taggants that could be used in the invention include any element with an atomic number ranging from 6 to 94.

The type of taggant depends, among other things, on the target object in which it is located. The material of the target object can interfere with the XRF detection because, as described below, backscattering and peaks emitted by the composition of the target object during XRF analysis can interfere with the taggant peaks. For example, if paper (as the target object) contained an As taggant and trace amounts of Pb existed in the paper, the K-level electrons of As and L-level electrons of Pb could give confusing readings during XRF detection.

The type of the taggant also depends, in part, on the other anti-counterfeiting technology with which the invention is used. For example, in one aspect of the invention, the taggant and XRF detection are used in combination with 2d data labels. The taggant (and accompanying XRF detection method) should be selected so that the method of identifying the taggant does not interfere with the 2d data label (or its accompanying method of identification).

In one aspect of the invention, the type of taggant should be selected based on the ability of the taggant and/or the substance in which it is located (i.e., a coating) to attach or bond to the target object. In many instances, the target object will be used, handled, and/or washed extensively. If the taggant (or the substance in which is located) is removed from the target object under such conditions, tagging the target object is of little value. For example, if a film or coating (e.g., ink) containing a taggant is applied to a target object (e.g., paper), the taggant and coating should be selected so that they will not be removed by the conditions to which the target object is periodically subjected (e.g., extensive contact with hands). Preferably, the coating and/or the taggant is selected in this aspect of the invention so that it chemically attaches or bonds to the target object, like paint attaches and bonds with a wall.

In another aspect of the invention, the type of taggant can be selected based on the ability of the taggant and/or the substance in which it is located, such as a coating, to be removed from the target object. In many instances, the purpose for which the target object is tagged will be temporary. After this purpose is completed, the taggant is no longer needed and can optionally be removed. For example, if an identifying film or coating containing a taggant is applied to a target object, once that object has been identified, the identifying film of coating may no longer be needed and can be removed by suitable means. Preferably, the coating and/or the taggant is selected in this aspect of the invention so that it is removable by mechanical or chemical means.

The amount and concentration of the taggant in the target object can also vary depending on the number of elements used and energy needed. The amount of taggant employed in the invention is determined by the minimum amount needed for XRF detection. Additional amounts of taggant can be used as described below. The concentration of the taggant is at least about 1 part per million (ppm), and can range from about 1-100 ppm. Larger taggant amounts can be used, but for economic reasons, a small amount is sufficient. Even lower taggant concentrations can be used (i.e., less than 1 ppm) as improved XRF devices and techniques become available.

The form of the taggant in the target object can also vary. The form can be any compound (i.e., salt) or molecule—either small or large—containing the element that is added by itself or with other components. Indeed, the taggant can be combined with various components and/or additives to make a mixture and/or solution. These other components or additives can be selected for various purposes, e.g., to modify the XRF properties, to modify the ability to be inserted into the target object, to stabilize the mixture or solution, or other purpose known in the chemical arts.

In one aspect of the invention, the at least one taggant is a combination or plurality of taggants. A plurality of taggants could include more than one taggant of the same type, e.g., the same element or compound. A combination of taggants could also be more than one type of taggant, e.g., a different element or compound in different media. For example, a taggant can be dispersed in ink that has been placed on paper that also contains the same or different taggant. The plurality of taggants could also include a combination of at least one intrinsic and at least one extrinsic taggant.

The at least one taggant incorporated in the target material can provide a distinctive code. Such a code could be based on the number and types of taggants present or absent, an abundance ratio (i.e., concentrations) of the same or different taggants, the location of the taggants within the object (i.e., a barcode made of a series of taggants with a space, where the space could be part of the code), the presence of multiple types or forms of a single taggant, or a combination thereof.

As one example of such a code, the invention can include a system in which the concentration of one taggant in a target object is controlled to provide a distinctive code. For example, for tagging ten commercially prepared batches of carpeting, the taggant yttrium oxide can be used. Ten unique codes could then be created for these ten batches by preparing samples of the target object containing various concentrations (i.e., 10 ppm, 20 ppm, . . . 100 ppm) of that taggant.

The number of unique codes available with the use of just a single taggant depends on the precision with which that concentration can be controlled and measured in the sample. For example, if techniques allow concentrations in about 10 ppm increments, 10 unique codes (i.e., 10 ppm, 20 ppm, . . . 100 ppm) can readily be constructed from a single taggant for that concentration range. Additional codes could be created for larger concentration ranges, e.g., 100 codes of a concentration ranging from 10 ppm to 1000 ppm in 10 ppm increments. With the advent of superior concentration and detection techniques (e.g., for smaller increments), more codes may be constructed.

Further, the number of unique codes can be increased by adding additional types and concentrations of the same or different taggants. A significant increase in the number of possible codes can be achieved by using more than one taggant in creating the code. For example, the code can be expanded by adding another taggant with its own specific concentrations. The number of codes can be further expanded by adding a third taggant with its own specific concentrations. Additional taggants could be used to provide even more codes. This coding system depends on the concentration increments of each of the taggants.

The number of codes available in the coding system could also be increased by varying the location of the taggant(s) within the object to be detected. For example, the detected material could be divided into any number of portions (i.e., quadrants) with certain taggants (or codes) being placed in certain of those portions, and optionally not in others, to signify additional information during the XRF analysis.

When taggants include elements or compounds that may be found in the target object or in the environment to which that object may be exposed, taggant contamination may occur and possibly render the taggant code difficult to read. For example, if a taggant comprising titanium oxide is located in carpet as the target object, it is possible that additional amounts of the taggant(s) could be present in the carpet as a result of environmental contamination, an internal chemical reaction, or other contamination. If this contamination occurs, there will be a change in the concentration of that taggant in the target object. Subsequent measurement of this taggant could yield a value corresponding to an incorrect code.

In such an instance, it is difficult to determine what amount of the taggant present in the target object is “contamination” as opposed to taggant present before contamination. This problem can be solved in target objects for which contamination might be suspected by using a backup (i.e., duplicate or otherwise) or secondary system, such as a backup or secondary taggant(s), backup or secondary code, or backup or secondary location. See, for example, the description in U.S. Pat. No. 5,760,394, the disclosure of which is incorporated herein by reference. If desired, more than one such backup or secondary system can be used. The backup or secondary system can also be used for other purposes, e.g., to verify the original coding system.

Any suitable target object can be employed in the invention. Suitable target objects include those which intrinsically contain the desired taggant(s) or in which the desired taggant(s) can be incorporated. Because XRF detection measures changes in the inner shell(s) of the taggant, it will not be significantly modified by chemical reactions that normally occur in the outer shells. Thus, it is possible to tag chemicals and have the taggant code be carried in any object manufactured with those chemicals. Target objects should be comprised of a material in which XRF detection is easy, e.g., little chance of background contamination, taggant deterioration, taggant destruction, contamination, or other deteriorating condition.

Examples of suitable target objects include any manufactured goods or trade goods. Examples of manufactured goods include any of those goods listed in the 2000 and 3000 series of the SIC classification index. Examples of trade goods include any of those goods listed in the 5000 series of the SIC classification index.

Manufactured goods include the following textile mill goods: cotton, manmade, and wool broadwoven fabric mills; narrow fabric mills; knitting mills like hosiery and women's hosiery, knit outerwear and underwear mills, weft-knit fabric mills, lace & warp knit fabric mills, and knitting mills; non-wool textile finishing like cotton and manmade finishing plants; carpets and rugs; yarn and thread mills like yarn spinning mills, thread mills, and throwing and winding mills; and miscellaneous textiles goods like coated fabrics (not rubberized), tire cord and fabrics, and non-woven fabrics, and cordage and twine.

Manufactured goods also include the following apparel and other textile goods:

men's and boys' suits and coats; men's and boys' furnishings including shirts, underwear and nightwear, trousers and slacks, work clothing, and other clothing; women's and misses' outerwear like blouses, shirts, dresses, suits, and coats; woman's and children's undergarments like underwear, bras, girdles, and allied garments; hats and caps (and millinery); girls' and children's outerwear like dresses and blouses; fur goods; other miscellaneous apparel and accessories like fabric dress and work gloves, robes and dressing gowns, waterproof outerwear, leather and sheep-lined clothing, and belts; as well as other fabricated textile products like curtains, house furnishings, textile bags, canvas and related goods, pleating and stitching, automotive and apparel trimmings, and machine embroidery.

Manufactured goods also include the following lumber and wood-based goods: logging goods; sawmills and planing mills including flooring mills and special product mills; millwork/plywood and structural members like millwork, wood kitchen cabinets, hardwood veneer and plywood, softwood veneer and plywood, and structural wood members; wood containers like nailed wood boxes and shook, as well as wood pallets and skids; wood buildings (includes those prefabricated) and mobile homes); and other wood products like wood preserving and reconstituted wood products.

Manufactured goods also include the following furnitures and fixtures: household furniture like wood furniture, upholstered furniture, metal furniture, mattresses and bedsprings, wood televisions, and wood radio cabinets; office furniture like wood furniture, upholstered furniture, and metal furniture; public building & related furniture; partitions and fixtures including wood partitions and fixtures, non-wood partitions and fixtures, and drapery hardware and blinds and shades.

Manufactured goods also include the following paper and allied products: pulp mills; paper mills; paperboard mills; paper board container and boxes including setup paperboard boxes, corrugated and solid fiber boxes, fiber cans and drums (and similar products), sanitary food containers, and folding paperboard boxes; converted paper products like coated or laminated paper (including packaging), plastic, laminated or coated bags, uncoated paper (and multiwall) bags, die-cut paper and board, sanitary paper products, envelopes, and stationary products.

Manufactured goods also include the following printing and publishing goods: newspapers; periodicals; books (both publishing and printing); miscellaneous publishing; commercial printing including lithographic printing and gravure printing; manifold business forms; greeting cards; blankbooks and bookbinding like blankbooks, looseleaf binders, and bookbinding and related work; and printing trade services including typesetting and platemaking goods.

Manufactured goods also include the following chemicals and allied products: industrial inorganic chemicals including alkalies and chlorine, industrial gases, inorganic pigments, and industrial inorganic chemicals; plastic materials and synthetics including plastics materials and resins, synthetic rubber, cellulosic manmade fibers, and non-cellulosic organic fibers; drugs and pharmaceuticals including medicinals and botanicals, pharmaceutical preparations, diagnostic substances, and non-diagnostic biological products; soaps, cleaners and toilet goods like soaps and other detergents, polishes and sanitation goods, surface-active agents, and toilet preparations; paints and allied products; industrial organic chemicals including gum and wood chemicals, and cyclic and crude and intermediates; agricultural chemicals including nitrogenous fertilizers, phosphatic fertilizers, and mixing fertilizers; and other chemical products including adhesives and sealants, explosives, inks, carbon blacks, and other chemical preparations.

Manufactured goods also include the following petroleum and coal products: petroleum refining goods; asphalt paving and roofing materials including asphalt paving mixtures and blocks and asphalt felts and coatings; as well as lubricating oils and greases.

Manufactured goods also include the following rubber and miscellaneous plastics products: tires and inner tubes; rubber and plastics footwear; hose and belting and gaskets and packing including rubber and plastic hoses and belting, as well as gaskets, packing and sealing devices; fabricated rubber products including mechanical rubber goods; and other plastics products including unsupported plastics film & sheets, unsupported plastics profile shapes, laminated plastics plate & sheet, plastic pipes, plastic bottles, plastic foam products, custom compound purchased resins, and plastics plumbing fixtures.

Manufactured goods also include the following leather and leather products: leather tanning and finishing goods; footwear cut stock; non-rubber footwear including house slippers, non-athletic men's footwear, and non-athletic women's footwear; leather gloves and mittens; luggage; handbags and personal leather goods including women's handbags and purses; and other leather goods.

Manufactured goods also include the following stone, clay, and glass goods: flat glass; pressed or blown glass and glassware including glass containers; purchased glass products including hydraulic cement; structural clay products including brick and structural clay tile, ceramic wall and floor tile, and clay refractories; pottery and related products including vitreous plumbing fixtures, vitreous china table and kitchenware, semi-vitreous table & kitchenware, and porcelain electrical supplies; concrete, gypsum and plaster products including concrete block and brick, ready-mixed concrete, lime, other concrete products, and gypsum products; cut stone and stone products; and other nonmetallic mineral products including abrasive products, asbestos products, minerals, ground or treated goods, mineral wool, nonclay refractories, and other nonmetallic mineral products.

Manufactured goods also include the following primary metal industrial goods: blast furnace and basic steel products including blast furnaces and steel mills, electrometallurgical products, steel wire and related products, cold finishing of steel shapes, and steel pipe and tubes; iron and steel foundry goods including gray and ductile iron foundries, malleable iron foundries, and steel investment foundries; primary nonferrous metals including primary copper and primary aluminum; secondary nonferrous metals; nonferrous rolling and drawing goods including copper rolling and drawing, aluminum sheet, plate, and foil goods, aluminum extruded products, other aluminum rolling and drawing goods, nonferrous rolling and drawing goods, and nonferrous wiredrawing & insulating; nonferrous foundries including aluminum die-castings, nonferrous die-casting except aluminum, aluminum foundries, copper foundries, and other nonferrous foundries; and miscellaneous primary metal products including metal heat treating.

Manufactured goods also include the following fabricated metal products: metal cans and shipping containers including metal cans and metal barrels, drums, and pails; cutlery, handtools and hardware including cutlery, hand and edge tools, saw blades and handsaws, and other hardware; plumbing and heating goods including metal sanitary ware, plumbing fixture fittings and trim, and non-electric heating equipment; fabriucated structural metal products including fabricated structural metal, metal doors, sash, and trim, fabricated plate work (boiler shops), sheet metalwork, architectural metal work, prefabricated metal buildings, and miscellaneous metal work; screw machine products including bolts, nuts, and washers; metal forgings and stampings including iron and steel forgings; nonferrous forgings; automotive stampings, crowns and closures, and other metal stampings; metal services including plating, polishing, and metal coating and allied services; ordnance and accessories including ammunition, small arms ammunition, and small arms; miscellaneous fabricated metal products including industrial valves, fluid power valves & hose fittings, non-wire steel springs, valves and pipe fittings, wire springs, miscellaneous fabricated wire products, metal foil and leaf, fabricated pipe and fittings, and other fabricated metal products.

Manufactured goods also include the following industrial machinery and equipment: engines and turbines including turbines and turbine generator sets, as well as internal combustion engines; farm and gardening machinery including farm machinery and equipment, as well as lawn and garden equipment; conduction and related machinery including construction machinery, mining machinery oil and gas field machinery, elevators and moving stairways, conveyors and conveying equipment, hoists, cranes and monorails, and industrial trucks and tractors; metal working machinery including metal-cutting machine tools, metal forming machine tools, industrial patterns, special dies, tools, jigs and fixtures, machine tools accessories, power-driven handtools, rolling mill machinery, welding apparatus, and other metalworking machinery; special industry machinery including textile machinery, woodworking machinery, paper industries machinery, printing trades machinery, food products machinery, and other special industry machinery; general industrial machinery including pumps and pumping equipment, ball and roller bearings, air and gas compressors, blowers and fans, packaging machinery, speed changers, drives, and gears, industrial furnaces and ovens, other power transmission equipment, and other general industrial machinery; computer and office equipment including electronic computers, computer storage devices, computer terminals, computer peripheral equipment, calculating and accounting equipment, and other office machines; refrigeration and service machinery including automatic vending machines, commercial laundry equipment, refrigeration and heating equipment, measuring and dispensing pumps, and other service industry machinery; industrial machinery including carburetors, pistons, rings, and valves, fluid power cylinders and actuators, fluid power pumps and motors, non-laboratory scales, and other industrial machinery.

Manufactured goods also include the following electronic and electric equipment: electric distribution equipment like non-electronic transformers and switchgear and switchboard apparatus; electrical industrial apparatus including motors and generators, carbon and graphite products, relays and industrial controls, and other electrical industrial apparatus; household appliances including cooking equipment, refrigerators and freezers, laundry equipment, electric housewaresa and fans, vacuum cleaners, and other household appliances; electric lighting and wiring equipment including electric lamps, current-carrying (and non current-carrying) wiring devices, residential lighting fixtures, commercial lighting fixtures, vehicular lighting equipment, and other lighting equipment; household audio and video equipment including pre-recorded records and tapes; communications equipment including telephone and telegraph apparatus, radio and telephone communications equipment, and other communications equipment; electronic components and accessories including electron tubes, printed circuit boards, semiconductors and related devices, electronic capacitors, electronic resistors, electronic coils and transformers, electronic controllers, and other electronic components; and miscellaneous electrical equipment and supplies including storage batteries, dry and wet primary batteries, engine electrical equipment, magnetic and optical recording media, and other electrical equipment and supplies.

Manufactured goods also include the following transportation equipment: motor vehicles and equipment including motor vehicles and car bodies, truck and bus bodies, motor vehicle parts and accessories, truck trailers, and motor homes; aircraft and parts including aircrafts, aircraft engines and engine parts, and aircraft parts and equipment; ship and boat building and repairing; railroad equipment; motorcycles, bicycles, and parts; guided missiles, space vehicles and parts including guided missiles and space vehicles, space propulsion units and parts, and other space vehicle equipment; miscellaneous transportation equipment including travel trailers and campers, tanks and tank components, and other transportation equipment.

Manufactured goods also include the following instruments and related products: search and navigation equipment, measuring and controlling devices including laboratory apparatus and furniture, environmental controls, process control instruments, fluid meters and counting devices, electricity-measuring instruments, analytical instruments, optical instruments and lenses, and other measuring and controlling devices; medical instruments and supplies including surgical and medical instruments, surgical appliances and supplies, dental equipment and supplies, x-ray apparatus and tubes, and electromedical equipment; ophthalmic goods; photographic equipment and supplies; watches, clocks, watchcases and parts.

Manufactured goods also include the following miscellaneous manufacturing goods: jewelry, silverware and plate ware including precious metal jewelry, silverware and plated ware, and jewelers' materials and lapidary work; musical instruments; toys and sporting goods including dolls and stuffed toys, games, toys and children's vehicles, and sporting and athletic goods; pens, pencils, office and art supplies including pens and mechanical pencils, lead pencils and art goods, marking devices, and carbon paper and inked ribbons; costume jewelry and notions including costume jewelry and fasteners, buttons, needles and pins; and miscellaneous manufactured goods including brooms and brushes, signs and advertising specialties, burial caskets, hard surface floor coverings, and other manufactured goods.

Trade goods include both durable goods and nondurable goods. Durable goods include the following motor vehicles, parts, and supplies including automobiles and other motor vehicles, motor vehicle supplies and new part, tires and tubes, and used motor vehicle parts; furniture and home furnishings; lumber and construction materials including lumber, plywood and millwork, brick, stone and related materials, roofing, siding and insulation, and other construction materials; professional and commercial equipment including photographic equipment and supplies, office equipment, computers, peripheral and software, other commercial equipment, medical and hospital equipment, ophthalmic goods, and other professional equipment; non-petroleum metals and minerals including metals service centers and offices, as well as coals and other minerals and ores; electrical goods including electrical apparatus and equipment, electrical appliances, television and radios, and electronic parts and equipment; hardware, plumbing and heating equipment including hardware, plumbing and hydronic heating supplies, warm air heating and air-conditioning, and refrigeration equipment and supplies; machinery, equipment and supplies including construction and mining machinery, farm and garden machinery, industrial machinery and equipment, industrial supplies, service establishment equipment, and transportation equipment and supplies.

Durable goods include the following miscellaneous durable goods: sporting and recreational goods, toys and hobby goods and supplies, scrap and waste materials, jewelry and precious stones, and other durable goods.

Non-durable goods include the following goods: paper and paper products including printing and writing paper, stationary and office supplies, and industrial and personal service paper; drugs, proprietaries and sundries; appararel, piece goods and notions including piece goods and notions, men's and boy's clothing, women's and children's clothing, and footwear; groceries and related products including general groceries, packaged frozen foods, non-dried or non-canned dairy products, poultry and poultry products, confectioneries, fish and seafood, meats and meat products, fresh fruits and vegetables, and other groceries and related products; farm-product war materials including grain and field beans and livestock; chemicals and allied products including plastic materials and basic shapes and chemical and allied products; petroleum and petroleum products including petroleum bulk stations and terminals, as well as petroleum products; beer wine and distilled beverages including beer and ale, as well as wine and distilled beverages; and miscellaneous nondurable goods including farm supplies, books, periodicals and newspapers, flowers and florist supplies, tobacco and tobacco products, paints, varnishes and supplies, and other nondurable goods.

Examples of suitable target objects also include those that will be subsequently changed. For example, a target object that is suspected might be destroyed could be tagged with elements known to be present in the residue from the destruction. Since the taggant is not usually changed by the chemical process in destruction, a connection between the target object and its residue could be established after destruction. Preferably, the target object of the invention is an aerospace product or component thereof.

The target objects containing the at least one taggant can be used for a wide number of applications. For example, tagging paints would allow any article coated with that paint to be identified. In another example, tagging paper and ink used in the paper (or applied to the paper) can be used to establish the authenticity of documents and currency. In yet another example, many manufactured items prone to counterfeiting or theft could benefit from tagging. Tagged threads in clothing could be used to encode information about the date, time, and place of manufacture. Tagging the bulk materials used in the manufacture of such items as aerospace products, compact discs, computer disks, video tapes, audio tapes, electronic circuits, and other items would be useful in tracing and prosecuting theft and counterfeiting cases involving these items.

In the invention, the at least one taggant can be incorporated into the target object in any suitable form. Suitable forms include those which place that taggant in the target object with little to no damage (either chemical or physical) to that object. See, for example, the description in U.S. Pat. Nos. 5,208,630, 5,760,394, and 6,030,657, the disclosures of which are incorporated herein by reference. Other suitable forms include using materials containing the taggant such as particulates like microparticles; solvents; coatings and films; adhesives; sprays; or a hybrid or combination of these methods. In any of these forms, the at least one taggant can be incorporated by itself or with another agent.

The at least one taggant can be incorporated in the target object using any suitable technique. Many existing tagging techniques involve the use of microparticles containing the elements, or compounds or compositions of the elements, comprising the at least one taggant. Additionally, particles can be manufactured wherein smaller particles, or compounds or compositions of the elements, containing the taggant. Such particles could be made of: magnetic or fluorescent materials to facilitate collection; refractory materials to enhance particle survival in an explosion; or chemically inert materials to enhance particle survival in a chemical reaction. Indeed, such particles could be made of non-durable, soluble, or reactive materials to enhance taggant dispersal in a fluid, aerosol, or powder system.

When the target object is a liquid article like paints or inks, or adhesives, or has a liquid component, the at least one taggant can be incorporated as an element or compound in solution with the liquid. Thus, the at least one taggant can be incorporated in elemental or compound form either in solution or suspension in the target object. The at least one taggant could also be dissolved or suspended in a solvent used in making the target object so that when that solvent evaporates, the residue left behind would contain the at least one taggant.

The taggant can be inserted into the target object of an article either during or after the article (or a part thereof) has been manufactured. The taggant can be manufactured as a component of the article or as part of a component of the article. During manufacture, the at least one taggant can also be incorporated into another material which comprises part of the target object. Indeed, the at least one taggant could also be an element or compound of the target object itself. The taggant can be incorporated into any location (including surfaces) of the article. Two (and three) dimensional shapes and patterns of the at least one taggant can be constructed using any desired combination of types and numbers of taggants.

The at least one taggant could also be incorporated after manufacture of the target object. The at least one taggant could be incorporated into the already formed target object as a dopant. Additionally, the taggant can be implanted into the object or deposited as a coating or film on the object. As a coating or film, the at least one taggant could be physically or chemically deposited by itself. The at least one taggant could also be incorporated as one ingredient (or contaminant) of another material (such as a mixture or solution) which forms a coating or film. In this aspect of the invention, the at least one taggant can be incorporated as an element or compound in solution (or suspension) with a liquid which is applied, such as by spraying, to the object. For example, the at least one taggant could be dissolved or suspended in a solvent so that when that solvent evaporates after being applied to the object, the residue left behind would contain the at least one taggant.

As apparent from the description above, the invention has the ability to easily tag small batches of target objects with a code unique to that batch. This can be done manually or in an automated system where each batch (or select batches) of the target object receives a different code. For example, 1000 (or 100) compact discs could be manufacture and each could be tagged with a code of a number from 1 to 1000 (or 1 to 100). Economic and processing considerations, however, might limit the minimum size of each batch and the number of batches that could be tagged.

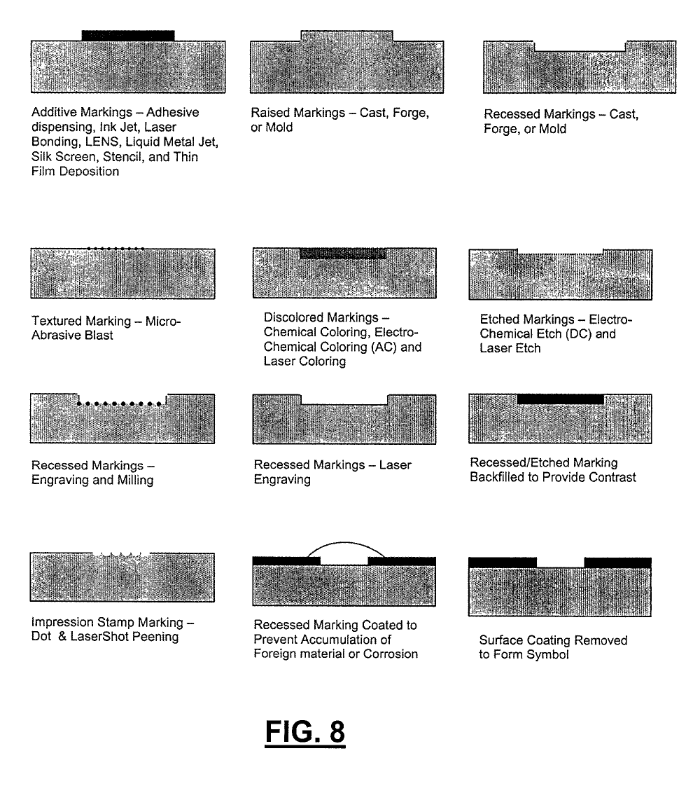

In one aspect of the invention, the method and apparatus of the invention can be used in combination with, in addition to, or in place of anti-counterfeiting technologies. For example, the invention can be used in combination with, in addition to, or in place of 2d data labels (“2d labels”). The conventional bar code symbol is “one-dimensional” in that the bars and spaces extend only in a single direction. To increase the information in machine-readable symbols, 2d labeling stores the information in two dimensions (i.e., a matrix) instead of a single dimension. See, for example, FIG. 7. Thus, the amount of information stored in the same amount of space can be increased more than 100 fold.

Most 2d labels are based on a wide range of technologies to both create the 2d labels, as well as to “read” the labels. 2d labels are usually created by modifying the surface of the object or product in some manner, including—but certainly not limited to—the following technologies: abrasive blast; adhesive dispensing; cast, forge or mold; dot peen; electro-chemical coating or etching; embroidery; engraving or milling; laser bonding or marking or peening; liquid metal jet; ink jet; silk screen; or stenciling (mechanical, laser, or photolithraphic). Using these methods, the surface of the object is modified to contain the two dimensional information.

The 2d labels are generally read using optical scanning techniques, such as scanning laser beams or CCD scanning. The resulting electrical signals are then decoded to recover the data encoded in the symbols of the 2d label. Recent advances in 2d labeling techniques have allowed other types of techniques to be employed for detecting the information, including magneto-optic, ultrasound, infrared (thermal) imaging, capacitance, and radar. Such additional technologies have allowed the symbols in the 2d labels to be embedded beneath protective coating or within assemblies for security, aesthetic, and symbol-protection reasons. See, for example, the description in the brochure entitled Innovative Technologies For Two-Dimensional Identification Coding NASA Marshall Space Flight Center (Feb. 27, 2002), the disclosure of which is incorporated herein by reference.

The size needed for the 2d labels, however, is still quite large. Because of the method in which the 2d labels are made (using squares in a matrix) and detected, the matrix for the 2d labels is at least 0.25 square inches. Often, the size need is large, e.g., 0.5 to 1 square inch (or even more).

The invention extends the capabilities of the 2d labels in several manners. First, the invention is able to identify and track/trace an object without having to modify the surface of the object. As noted above (and as illustrated in FIG. 8), current 2d labeling techniques modify the surface of the object in some manner to create the label. Using the taggant and XRF detection described herein, the invention need not modify the surface of the object at all.

As well, the invention is able to identify and track/trace on object without the need for the size required for 2d labeling techniques. As described above, 2d labeling techniques require a certain size on the object (generally 0.25 to 1 square inch). Using the taggants of the invention, such sizes are not required. Indeed, in one aspect of the invention, the sizes needed for the taggants of the invention can be on the microscopic level.

The invention also is not limited to a “matrix” shape. 2d labeling techniques generally use information stored in a matrix form, as depicted in FIG. 7. The invention, however, is not so limited to this matrix form. Indeed, based on the manner in which the taggant is incorporated into the object as described above, the taggant can be present in any form or style in the object. Further, the invention is not limited to two dimensions, but can create a “label” in three dimensions.

2d labeling techniques are highly dependent on the substrate in which the label is formed, e.g., type of material, surface roughness, geometry of surface, etc. . . . The invention, however, is not so limited to the substrate. Indeed, in most instances, the invention can be used with all types of substrates.

In one aspect, the invention can be used in place of 2d labeling technologies. The invention serves the same functions as many 2d labeling technologies. Indeed, the invention improves on such functions and adds additional functions and, therefore, would be highly desirable to use in place of 2d labeling technologies.

In another aspect, the invention can be used in combination with 2d labeling technologies. In this aspect of the invention, the taggant and XRF detection method are combined with the 2d label in any manner that does not interfere with creating or detecting the 2d label. As an example of this aspect of the invention, a taggant could be incorporated in the 2d label during an abrasive blasting process by placing the taggant in the abrasive material. Some of the abrasive material and taggant would be mechanically bonded to the substrate surface on which the 2d label is formed due to the force of the blast. The 2d label could be optically scanned to provide the information contained therein while the taggant could be detected via XRF to provide the data contained therein.

Similarly, the taggant could be incorporated in other processes (such as placing the taggant in the deposition materials during a thin film deposition process) for making 2d labels to combine the invention with the 2d label. In combining the 2d labels with the invention, however, the method of incorporating the taggant into the 2d label need not be performed simultaneously: the method of creating the 2d label and the method of incorporating the taggant could be performed separately.

In another aspect, the invention can be used in addition to 2d labeling technologies. In this aspect of the invention, the taggant and XRF detection can be used in one part of the object or its packaging and the 2d labeling can be used in another part of the object. For example, when the 2d label is typically placed on the surface of an aerospace component and the taggant could be located (i.e., embedded) with that component. Alternatively, the taggant could be placed near (or on) a difference surface of that component and/or could be placed in an adjacent aerospace component.

Likewise, the invention could be used in place of, in combination with, or in addition to other anti-counterfeiting technologies, e.g., other identification technologies or other track/trace technologies. In this aspect of the invention, the taggant and XRF detection method of the invention could extend the abilities of these technologies (like with the 2d labeling technology). For example, some anti-counterfeiting technologies (like bar codes) are used on the labels placed on individual bottles containing pharmaceuticals. The invention could be used in place of the bar code, could be used in combination with the bar code by placing the taggant in the bar code, and/or in addition to the bar code by locating the taggant in or on the lid, in or on the bottle, and (in certain instances) in or on the individual pharmaceuticals themselves.

By placing a taggant(s) in more than one location (or using the invention with other anti-counterfeiting technologies like 2d labels), the identification of the object can be custom-fit. As well, by using a central database with “codes” for all objects for a particular entity or organization, the objects can be quickly and securely tacked and traced.

After the at least one taggant is extrinsically or intrinsically present in the target object(s), the taggant(s) is detected to identify or verify the target material using XRF analysis as illustrated in FIG. 1. Primary x-rays 40 are used to excite a sample of the target material 46, and the secondary x-rays 44 that are emitted by the sample are detected and analyzed.

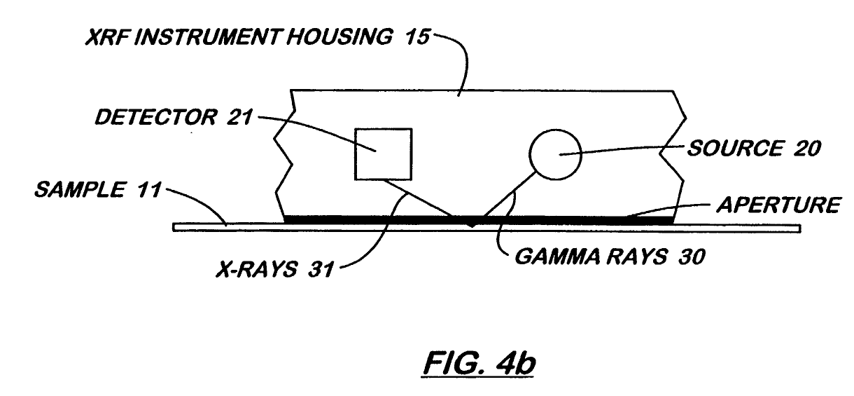

As shown in FIG. 3, the x-rays which are detected have various energies, e.g., there is a broad band of scattered x-rays with energies less than and greater than those of the exciting atom. FIG. 3 illustrates this spectrum for paper as the target object. Within this broad band, there are peaks due to the excitation of the taggant(s) in the sample. The ratio of the intensity of the radiation in any peak to the intensity of the background at the same energy (known as the peak-to-background ratio) is a measure of the concentration of the element which has characteristic X-rays at the energy of that peak, e.g., the taggant.

In one aspect of the detection method of the invention, at least one target object believing to contain known concentrations of the taggant(s) of interest is selected. The XRF analysis is performed on that target object (or a sample thereof) using a detection device or apparatus containing an x-ray radiation source (“source”), x-ray radiation detector (“detector”), support means, analyzer means, and calibration means.

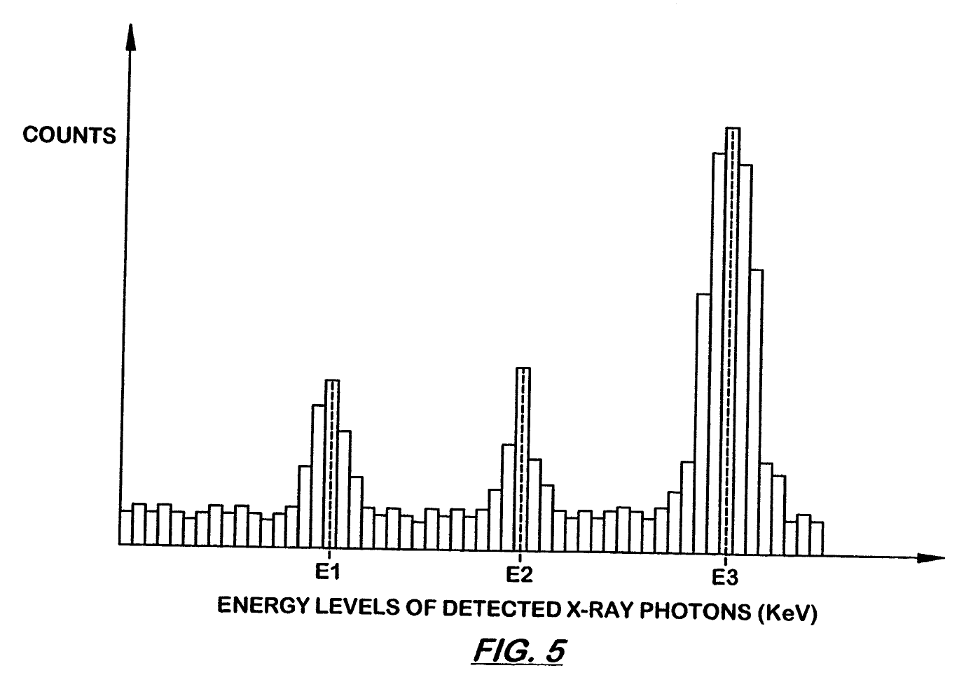

One aspect of the detection device of the invention is illustrated in FIG. 4a. In this Figure, the detection apparatus 25 has an ordinary x-ray fluorescence spectrometer capable of detecting elements present in a coating, package or material. X-rays 29 from a source (e.g., either x-ray tube or radioactive isotope) 20 impinge on a sample 11 which absorbs the radiation and emits x-rays 31 to an x-ray detector 21 and analyzer 23 capable of energy or wavelength discrimination. This is accomplished by using a commercially available x-ray spectrometer such as an Edax DX-95 or a MAP-4 portable analyzer, commercially available from Edax Inc., Mahwah, N.J. Part of analyzer 23 includes a computerized system 27.

Another aspect of the detection apparatus of the invention is illustrated in FIG. 4b. In this Figure, the detection apparatus 25 has an instrument housing 15 which contains the various components. Gamma rays or x-rays 30 from a source (e.g., either x-ray tube or radioactive isotope) 20 are optionally focused by aperture 10 to impinge on a sample 11. Sample 11 contains the at least one taggant which absorbs the radiation and emits x-rays 31 to an x-ray detector 21. Optionally, analyzing means can be incorporated within housing 15.

The invention, however, is not limited to the detection apparatus depicted in FIGS. 4a and 4b. Any suitable source, or plurality of sources, known in the art can be used as the source in the detection device of the present. See, for example, U.S. Pat. Nos. 4,862,143, 4,045,676, and 6,005,915, the disclosures of which are incorporated herein by reference. During the XRF detection process, the source bombards the taggant with a high energy beam. The beam may be an electron beam or electromagnetic radiation such as X-rays or gamma rays. The source, therefore, may be any material that emits such high energy beams. Typically, these have been x-ray emitting devices such as x-ray tubes or radioactive sources.

To target, the beam can be focused and directed properly by any suitable means such as an orifice or an aperture. The configuration (size, length, diameter . . . ) of the beam should be controlled, as known in the art, to obtain the desired XRF detection. The power (or energy level) of the source should also be controlled, as known in the art, to obtain the desired XRF detection.

The source(s) can be shielded and emit radiation in a space limited by the shape of the shield. Thus, the presence, configuration, and the material used for shielding the source should be controlled for consistent XRF detection. Any suitable material and configuration for that shield known in the art can be employed in the invention. Preferably, any high-density materials used as the material for the shield, e.g., tungsten or brass.

Any suitable detector, or plurality of detectors, known in the art can be used as the detector in the detection device of the invention. See, for example, U.S. Pat. Nos. 4,862,143, 4,045,676, and 6,005,915, the disclosures of which are incorporated herein by reference. Any type of material capable of detecting the photons omitted by the taggant may be used. Silicon and CZT (cadmium-zinc-telluride) detectors have been conventionally used, but others such as proportional counters, germanium detectors, or mercuric iodide crystals can be used.

Several aspects of the detector should be controlled to obtain the desired XRF detection. First, the geometry between the detector and the target material should be controlled. The XRF detection also depend on the presence, configuration, and material—such as tungsten and beryllium—used as a window to allow x-rays photons to strike the detector. The age of the detector, voltage, humidity, variations in exposure, and temperature can also impact the XRF detection and, therefore, these conditions should be controlled.

The analyzer means sorts the radiation detected by the detector into one or more energy bands and measures its intensity. Thus, any analyzer means performing this function could be used in the invention. The analyzer means can be a multi-channel analyzer for measurements of the detected radiation in the characteristic band and any other bands necessary to compute the value of the characteristic radiation as distinct from the scattered or background radiation. See, for example, U.S. Pat. Nos. 4,862,143, 4,045,676, and 6,005,915, the disclosures of which are incorporated herein by reference.

The XRF also depends on the resolution of the x-rays. Background and other noise must be filtered from the x-rays for proper measurement, e.g., the signals must be separated into the proper number of channels and excess noise removed. The resolution can be improved by cooling the detector using a thermoelectric cooler—such as a nitrogen or a peltier cooler—and/or by filtering. Another way to improve this resolution is to use pre-amplifiers.

The support means supports the source and detector in predetermined positions relatively to a sample of the target material to be irradiated. Thus, any support means performing this function could be used in the invention. In one example, the support means comprises two housings, where the source and detector are mounted in a first housing which is connected by a flexible cable to a second housing in which the analyzer means is positioned as illustrated in FIG. 4a. If desired, the first housing may then be adapted to be hand-held. In another example, the source and detector as well as the other components of the detection device are mounted in a single housing as illustrated in FIG. 4b.

The calibration means are used to calibrate the detection apparatus, thus insuring accuracy of the XRF analysis. In this calibration, the various parameters that could be modified and effect the measurement are isolated and calibrated. For example, the geometrical conditions or arrangements can be isolated and calibrated. In another example, the material matrix are isolated and calibrated. Preferably, internal (in situ) calibration during detection is employed as the calibration means in the invention. Components, such as tungsten shielding, are already present to internally calibrate during the XRF analysis. Other methods, such as fluorescence peak or Compton backscattering, could be used for internal calibration in the invention.

Analyzer means, which includes a computerized system 27, is coupled to, receives, and processes the output signals produced by detector 21. The energy range of interest, which includes the energy levels of the secondary x-ray photons 44 emitted by the taggant(s), is divided into several energy subranges. Computerized system 27 maintains counts of the number of X-ray photons detected within each subrange using specific software programs, such as those to analyze the detection and x-ray interaction and to analyze backscatter data. After the desired exposure time, computerized system 27 with display menus stops receiving and processing output signals and produces a graph of the counts associated with each subrange.

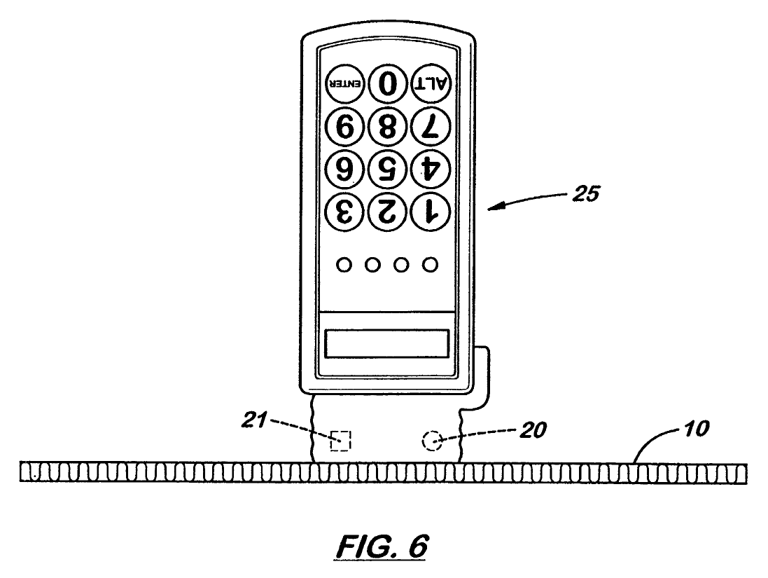

FIG. 5 is a representative graph of the counts associated with each subrange. This graph is essentially a histogram representing the frequency distribution of the energy levels E1, E2, and E3 of the detected x-ray photons. Peaks in the frequency distribution (i.e., relatively high numbers of counts) occur at energy levels of scattered primary x-ray photons as well as the secondary x-ray photons from the taggant(s). A primary x-ray photon incident upon a target material may be absorbed or scattered. The desired secondary x-ray photons are emitted only when the primary x-ray photons are absorbed. The scattered primary x-ray photons reaching the detector of the system create an unwanted background intensity level. Accordingly, the sensitivity of XRF analysis is dependent on the background intensity level, and the sensitivity of XRF detection may be improved by reducing the amount of scattered primary x-ray photons reaching the detector. The peak occurring at energy levels of scattered primary x-ray photons is basically ignored, while the other peaks—those occurring at E1, E2, and E3—are used to identify the at least one taggant present in the target object.

Besides the parameters described above, at least two other parameters must be controlled during the process of XRF detection. First, the media (such as air) through which the gamma rays (and x-rays) must travel also impacts the XRF. Therefore, the different types of media must be considered when performing the XRF analysis. Second, the methods used to interpret and analyze the x-rays depend, in large part, on the algorithms and software used. Thus, methods must be adopted to employ software and algorithms that will consistently perform the XRF detection.

These two parameters, plus those described above, must be carefully accounted for and controlled to obtain accurate measurements. In one aspect of the intention, these parameters could be varied and controlled to another provide a distinct code. For example, using a specific source and a specific detector with a specific measuring geometry and a specific algorithm could provide one distinct code. Changing the source, detector, geometry, or algorithm could provide a whole new set of distinct codes.

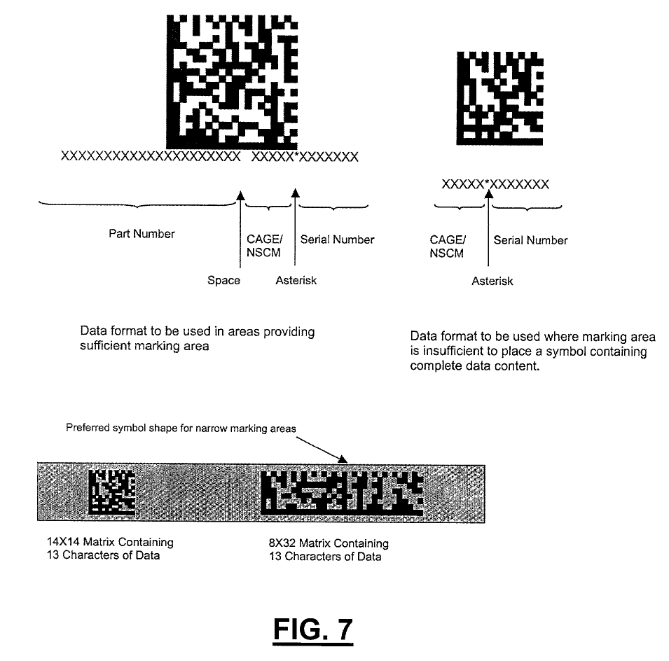

FIG. 6 illustrates a preferred apparatus and detection method according to the invention. In this Figure, detection apparatus 25 is capable of detecting at least one taggant present in target material 10, such as a document. Detection apparatus 25 is a portable device which can be small enough to be hand-held. Detection apparatus 25 contains all the components discussed above (i.e., source, detector, analyzer means, and calibration means) in a single housing, thus allowing the portability and smaller size.

The invention is not limited to any specific XRF analysis. Any type of XRF, such as total reflection x-ray fluorescence (TXRF), can be employed in the invention.

In one aspect of the invention, the apparatus and method used identify an object or article once it has been tagged. The ability to invisibly tag an article and read the tag, especially through a non line-of-sight method, provides an invaluable asset in any industry that authenticates, verifies, tracks, labels, or distributes goods of any kind. Indeed, having an invisible taggant(s) could further prevent copying and counterfeiting of goods. In another aspect of the invention, the apparatus and method of the invention could be used for these same purposes, but for those products that have the desired taggant already located therein. Thus, the inventions could analyze liquid flows for contaminant particles or pinpoint via 3-D analysis the exact location of a contaminant(s) in an article.

Having described the preferred aspects of the invention, it is understood that the invention defined by the appended claims is not to be limited by particular details set forth in the above description, as many apparent variations thereof are possible without departing from the spirit or scope thereof.

We claim:

1. A method for authenticating an object, comprising:
providing a taggant in a portion of an object;
causing the taggant to radiate an x-ray that penetrates through the portion of the object; and
analyzing through that portion whether the x-ray has a specific energy.

2. The method of claim 1, wherein the object contains additional means for authentication.

3. The method of claim 2, wherein the additional authentication means includes 2d labels.

4. The method of claim 1, wherein the object is a manufactured good or trade good.

5. The method of claim 1, wherein the taggant provides a code for authentication.

6. A method for tracking an object, comprising:
providing a taggant in a portion of an object;
causing the taggant to radiate an x-ray that penetrates through the portion of the object; and
analyzing through that portion whether the x-ray has a specific energy.

7. The method of claim 6, wherein the object contains additional means for tracking.

8. The method of claim 7, wherein the additional tracking means includes 2d labels.

9. The method of claim 6, wherein the object is a manufactured good or trade good.

10. The method of claim 6, wherein the taggant provides a code for tracking the object.

11. A method for authenticating an object, comprising:
providing an object with a first authentication means;
providing the object with a second authentication means, including providing a taggant in a portion of the object;
causing the taggant to radiate an x-ray that penetrates through the portion of the object; and
analyzing through that portion whether the x-ray has a specific energy.

12. The method of claim 11, wherein the first authentication means includes 2d labels.

13. The method of claim 11, wherein the object is a manufactured good or trade good.

14. The method of claim 11, wherein the second authentication means provides a code for authentication.

15. The method of claim 14, wherein the first and second authentication means together provide a code for authentication.

16. A method for tracking an object, comprising:
providing an object with a first tracking means;
providing the object with a second tracking means, including providing a taggant in a portion of the object;
causing the taggant to radiate an x-ray that penetrates through the portion of the object; and
analyzing through that portion whether the x-ray has a specific energy.

17. The method of claim 16, wherein the first tracking means includes 2d labels.

18. The method of claim 17, wherein the object is a manufactured good or trade good.

19. The method of claim 18, wherein the second tracking means provides a code for tracking.

20. The method of claim 19, wherein the first and second tracking means together provide a code for tracking.
